(19) United States
(12) Patent Application Publication
(10) Pub. No.: US 2019/0003516 A1
(43) Pub. Date: Jan. 3, 2019

(54) PLUG FOR CLOSING A FEMALE SCREW HOLE

(71) Applicant: NEWFREY LLC, New Britain, CT (US)

(72) Inventors: Yuuki AOSHIMA, Utsunomiya-shi (JP); Akira TANAKA, Toyota-shi (JP)

(21) Appl. No.: 16/023,603

(22) Filed: Jun. 29, 2018

(30) Foreign Application Priority Data
Jun. 30, 2017 (JP) 2017-129562

(51) Int. Cl. F16B 37/14

(52) U.S. Cl. CPC F16B 37/14; F16B 37/061

(57) ABSTRACT

A plug usable for closing mounting holes of body panels and holes of weld nuts of internal screws of various sizes. The plug has a flange which covers the hole. A column extends from the flange. Each of a pair of elastic stop bars are connected to the column at a bottom and elongate oblique upwardly. Each elastic stop bar has a first stop prong at the free end of the bar and a second stop prong nearer to the bottom. The distance between the first stop prong and the second stop prong is the same as the pitch of the internal screws of the weld nuts having sizes of M8, M10, and M12. The shapes of the prongs are the same as the shapes of the roots of the internal screws of sizes of M8, M10, M12, and M14.

### CROSS-REFERENCE TO RELATED APPLICATION

This application claims priority from Japanese Patent Application No. 2017-129562, filed on Jun. 30, 2017, the entire disclosure of which is incorporated herein by reference.

### BACKGROUND OF THE INVENTION

The present invention relates to an improvement of a plug for closing a female screw hole used for closing the hole of a mounted member (such as a body panel of an automobile, and the like) and the female screw hole of a female screw member for a configuration in which a female screw member is fixed to the mounted member corresponding to a hole formed on the mounted member.

A hole (hereinafter referred to as a receiving hole) for mounting various parts and the like is formed in a body panel (attached member) of an automobile, and a weld nut (female screw member) is fixed to the back surface of the body panel corresponding to this receiving hole. When attaching the parts or the like, the bolt part provided in the parts or the like is passed through the receiving hole of the body panel and screwed into the female screw hole of the weld nut. In such a configuration, in order to prevent invasion of water, foreign matter, and the like, it is desirable to close the receiving hole and the female screw hole, in which it is not necessary to attach the parts and the like, by a plug for closing a female screw hole.

Patent Document 1 (Japanese Unexamined Patent Publication No. 2009-156329) is known as a conventional technique related to a plug for closing a female screw hole. The plug for closing a female screw hole disclosed in this Patent Document 1 is equipped with a flange, a support post, and a plurality of elastic engaging pieces extending away from the support post toward the flange from the support post; the distal ends of these elastic engaging pieces are engageable with the slope of a screw thread corresponding to the lead angle of the screw thread of the female screw hole. That is, a configuration is taken wherein, when the support post and the elastic engaging pieces are inserted into the receiving hole of the body panel and the female screw hole of the weld nut, the distal end of each of the elastic engaging pieces engages with the inclined face of the thread of the female screw hole, and the center of the support post substantially matches the center of the female screw hole.

### SUMMARY OF THE INVENTION

The authors of the present invention considered ways for improving the versatility of weld nuts of various sizes with respect to the plug for closing a female screw hole disclosed in Patent Document 1. In particular, the authors studied a structure wherein, when weld nuts with which the thickness dimension of the body panel is small and the size is relatively small (for example, MS—nominal diameter is 8 mm—as the size of the weld nut) are used, or when weld nuts having a relatively large size (for example, when a weld nut having a size of M14—nominal diameter of 14 mm—is used), it is possible to stably block the receiving hole and the female screw hole.

The present invention has been made in view of the above points; the object of the invention is to provide a plug for closing a female screw hole which can enhance weld nut (female screw member) versatility with various sizes.

In order to achieve the above object, the means for solving the problem of the present invention is premised on a plug for closing a female screw hole used for closing the hole of a mounted member and the female screw hole of a female screw member for a configuration in which a female screw member is fixed to the mounted member corresponding to a hole formed on the mounted member. Further, the plug for closing a female screw hole is characterized by the provision of a flange sized to cover the entire hole of the mounted member; a support post extending from a central portion of the flange; a first engaging claw positioned on a pair or more of respective elastic engaging ends on the distal end of the elastic engaging piece, with the proximal end connected to the support post, so that as it approaches the flange from the proximal end toward the distal end, it moves away from the support post; and a second engaging claw positioned farther on a base end side of the elastic engaging piece with respect to the first engaging claw; wherein the interval between the first engaging claw and the second engaging claw matches the pitch of the female screw in each female screw member of at least sizes M8, M10 and M12; and the shapes of the first engaging claw and the second engaging claw are the same as the shape of the valley of the female screw in each female screw member of sizes M8, M10, M12 and M14.

With this particular aspect, when closing the hole of the mounted member and the female screw hole of the female screw member with the plug for closing a female screw hole, the support posts of the plug for closing a female screw hole and the respective elastic engaging pieces are inserted into the respective holes, and the entire hole of the mounted member is covered by the flange. At this time, installation is conducted in a state wherein the engaging claw (at least one of either the first engaging claw and/or the second engaging claw) of each elastic engaging piece is engaged with the inclined face of the thread of the female screw hole of the female screw member, so that the plug for closing a female screw hole is prevented from coming off. In this solution, the interval between the first engaging claw and the second engaging claw is set to be equal to the pitch of the female thread of each female screw member of at least size M8, MI0 and M12. Further, the shapes of the first engaging claw and the second engaging claw are the same as the shape of the valley of the female thread in each internal thread member of sizes M8, M10, M12 and M14. Therefore, one type of plug for closing a female screw hole can be made to correspond to various female screw members. That is, it is possible to realize a mounting configuration of a plug for closing a female screw hole corresponding to female screw members of various sizes, in states of installation such as when only the first engaging claw is engaged with the inclined face of the thread of the female screw hole of the female screw member, when only the second engaging claw is engaged with the inclined face of the thread of the female screw hole of the female screw member, or when both the first engaging claw and the second engaging claw are engaged with the inclined surfaces of the threads of the female screw hole of the female screw member. In this way, versatility of the plug for closing a female screw hole can be improved.

In the present invention, the first engaging claw and the second engaging claw are provided on the elastic engaging piece for engagement with the female screw hole with respect to the plug for closing a female screw hole that closes the hole of the attached member and the female screw hole of the female screw member; the interval between the engaging claws is made to match the pitch of the female screws in the female screw members of a plurality of sizes, and the shape of the first engaging claw and the second engaging claw is made the same shape as that of the valley of the female screw in the female screw members of a plurality of sizes. As a result, it is possible to achieve a mounting configuration of a plug for closing a female screw hole corresponding to female screw members of various sizes, and as a result, the versatility of the plug for closing a female screw hole can be enhanced.

### BRIEF DESCRIPTION OF THE DRAWINGS

FIG. 1 is a perspective view of a hole closing plug according to the invention.

FIG. 2 is a plan view of a hole closing plug according to the FIG. 1 embodiment.

FIG. 3 is a front view of the hole closing plug according to the FIG. 1 embodiment.

FIG. 4 is a cross-sectional view taken along line IV-IV in FIG. 2.

FIG. 5 is a cross-sectional view taken along line V-V in FIG. 2.

FIG. 6 is a cross-sectional view showing an engaged state of the hole closing plug with respect to a weld nut of M8 in the embodiment.

FIG. 7 is a cross-sectional view showing an engaged state of the hole closing plug with respect to the weld nut of M10 in the embodiment.

FIG. 8 is a cross-sectional view showing an engaged state of the hole closing plug with respect to the weld nut of M12 in the embodiment.

FIG. 9 is a cross-sectional view showing an engaged state of a hole closing plug with respect to a weld nut of M14 in the embodiment.

FIG. 10 is a cross-sectional view showing a case where a hole closing plug is applied to a weld nut of M8 in the prior art.

FIG. 11 is a sectional view showing a case where a hole closing plug is applied to a weld nut of M14 in the prior art.

### DESCRIPTION OF THE PREFERRED EMBODIMENTS

Hereinafter, embodiments of the present invention will be described with reference to the drawings. A plug for closing a female screw hole (hereinafter simply referred to as a hole closing plug) according to the present embodiment is used for closing a receiving hole of the body panel and a female screw hole of the weld nut, relative to the structure to which a weld nut (female screw member) is fixed in the body panel corresponding to the receiving hole formed in the body panel (attached member) of an automobile.

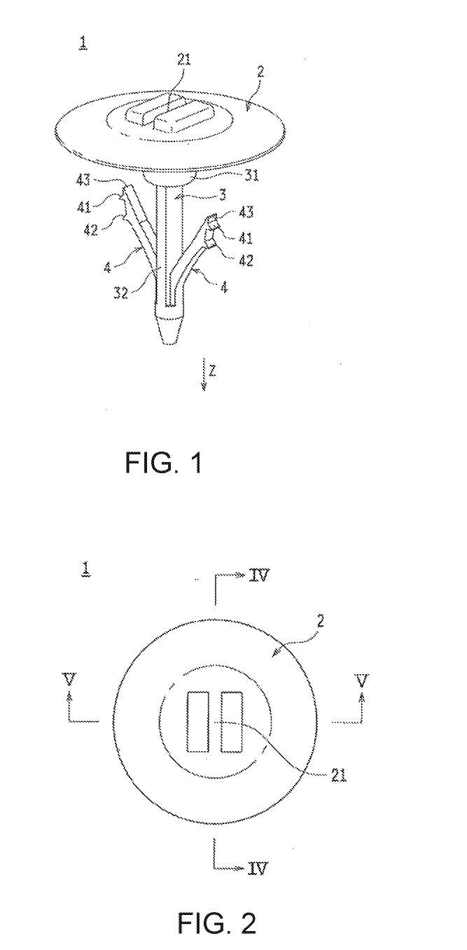

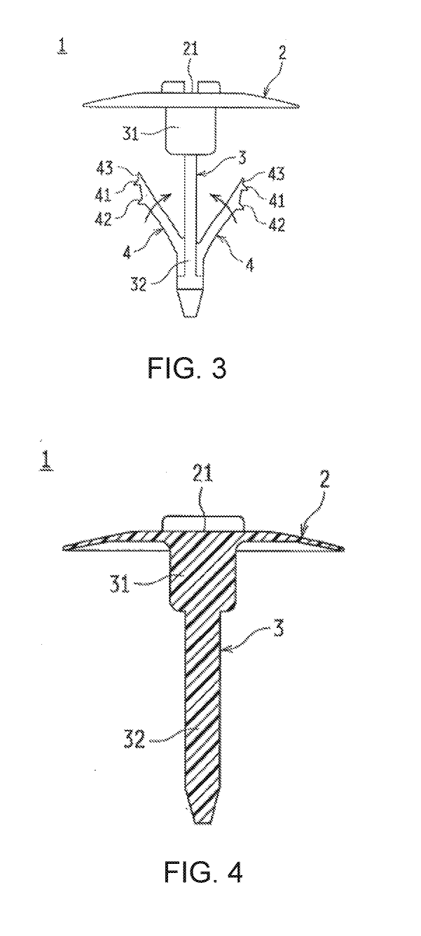

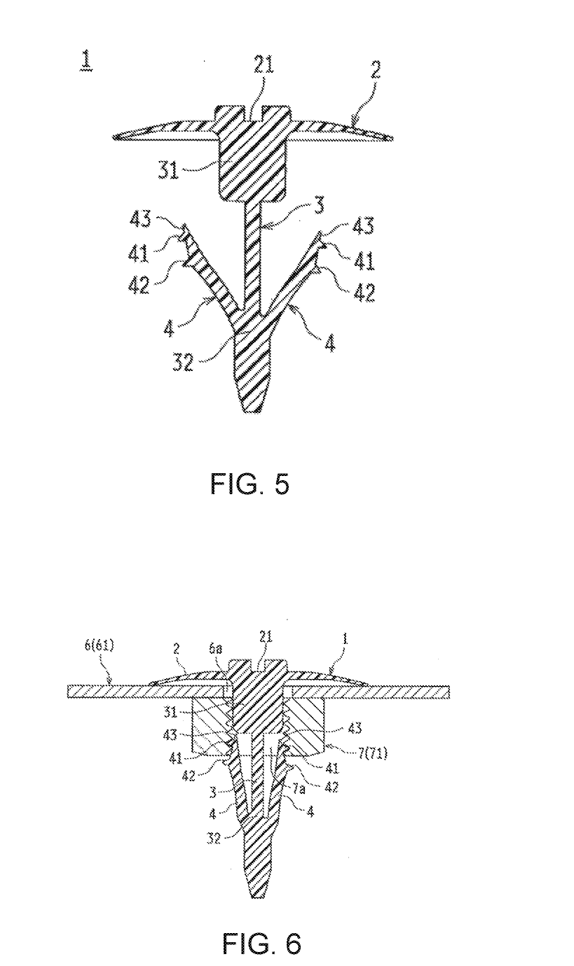

FIG. 1 to FIG. 5 show a hole closing plug 1 according to the present embodiment. FIG. 1 is a perspective view of a hole closing plug according to the embodiment. FIG. 2 is a plan view of a hole closing plug according to the embodiment. FIG. 3 is a front view of the hole closing plug according to the embodiment. FIG. 4 is a cross-sectional view taken along line IV-IV in FIG. 2. FIG. 5 is a cross-sectional view taken along line V-V in FIG. 2.

The hole closing plug 1 is formed of a thermoplastic synthetic resin. The thermoplastic synthetic resin is preferably relatively hard; according to this, engagement in the case where the hole closing plug 1 is inserted into the receiving hole 6a of the body panel 6 and the female screw hole 7a of the weld nut 7 (see FIG. 6, showing an example of the mounting state of the hole closing plug 1) is assured.

Hereinafter, for convenience, the insertion direction (the direction of the arrow Z in FIG. 1) of the hole closing plug 1 with respect to the receiving hole 6a of the body panel 6 will be referred to as downward, and this direction side will be referred to as the lower side.

The hole closing plug 1 is equipped with disk shaped flange 2, a support 3 extending downward from the center of the lower surface of the flange 2, and a pair of elastic engaging pieces 4, 4 extending away from the support 3 toward the flange 2 from the support 3 toward the flange 2.

The flange 2 is formed into a disk shape having a size that can cover the entire receiving hole 6a (see FIG. 6) of the body panel 6; in a state where the lower surface thereof abuts the body panel 6; the outer edge portion is formed in a thin-walled sucker shape so as to be able to close the receiving hole 6a of the body panel 6 and contact the body panel 6 over the entire circumferential direction thereof.

When inserting the support post 3 and the elastic engaging pieces 4, 4 of the hole closing plug 1 into the receiving hole 6a of the body panel 6 and the female screw hole 7a of the weld nut 7, the upper surface of the flange 2 is pressed toward each of the holes 6a, 7a by a finger, or the like. Further, on the upper surface of the flange 2, a groove 21 into which a tool such as a driver or the like is inserted when detaching the hole closing plug 1 from each hole 6a, 7a is formed. That is, by inserting a tool in the groove 21 and rotating the hole closing plug 1 around the axis of the flange 2 (by rotating in the reverse direction of the screw in the female thread of the weld nut 7 (counterclockwise direction in a plan view, for example), it is possible to remove the hole closing plug 1 from each of the holes 6a, 7a (this removal operation will be described later).

The support post 3 is formed in a rod shape that hangs down from the central portion of the lower surface of the flange 2. In addition, in this support post 3, the upper portion adjacent to the flange 2 is formed as a cylindrical portion 31 which enters into the receiving hole 6a of the body panel 6 and the female screw hole 7a of the weld nut 7. The outer diameter dimension of the cylindrical portion 31 is set to be substantially the same size as the smaller inner diameter dimension between the receiving hole 6a of the plurality of types of body panels 6 to be applied and the female screw hole 7a of the weld nut 7 (the inner diameter dimension of the female screw hole 7a of the weld nut 7 (71) of M 8 as will be described later) (see FIG. 6).

In the support post 3, the part below the cylindrical part 31 (hereinafter referred to as support post lower part 32) is set to have a smaller cross-sectional area than the cylindrical portion 31 and the cross-section shape as rectangular. The cross-sectional area of the support post lower part 32 retains the strength of the support 3 at a sufficient level, and when inserted into the receiving hole 6a of body panel 6, even if the lower end of the support 3 comes into contact with the opening edge of the receiving hole 6a, the value is set so that breakage or the like is not caused. In addition, the support post lower part 32 is a part where the elastic engaging pieces 4, 4 are integrally formed.

In addition, the distal end (lower end) part of the support post 3 is tapered so as to facilitate the action of insertion into the receiving hole 6a of the body panel 6.

With each of the elastic engaging pieces 4, 4, the base end on the lower side is connected to the support post lower part 32 of the support post 3. Specifically, as described above, in the support post lower part 32 whose cross section is set to have a rectangular shape, the base ends of the elastic engaging pieces 4, 4 are respectively connected to the side surfaces (the side surfaces on the left and right sides in FIG. 3) located on the opposite side of each other.

In addition, each of the elastic engaging pieces 4, 4 extends away from the support post 3 as it approaches the flange 2 (toward the upper side) from the base end to the tip (upper end). As basic functions of the elastic engaging pieces 4, 4, when the elastic engaging pieces 4, 4 are inserted into the female screw holes 7a of the weld nut 7, by contacting to the inner surface of the female screw hole 7a, the respective elastic latching pieces 4, 4 are elastically deformed toward the inside (the support post 3 side) (see arrow in FIG. 3), the end portions of the elastic engaging pieces 4, 4 (specifically, the engaging claws 41, 42 described later) are engaged with the inclined surfaces of the threads of the female screw hole 7a of the weld nut 7 by the action of the reaction force, so as to prevent the hole closing plug 1 from coming off from the weld nut 7.

As described above, the respective base ends of elastic engaging pieces 4, 4 are connected to the side surfaces which are positioned on opposite sides of each other on support post lower part 32. In other words, with each of the elastic engaging pieces 4, 4, the directions extending outward relative to the support post 3 are opposite to each other (the direction in which the 180° phase is present in the circumferential direction around the support post 3). Therefore, the respective elastic engaging pieces 4, 4 are inserted into the respective holes 6a, 7a, and each of the elastic engaging pieces 4, 4 is engaged with the inclined face of the thread of the female screw hole 7a of the weld nut 7; in this state, the reaction force resulting from the elastic deformation of each of the elastic engaging pieces 4, 4 acts so that the center of the support post 3 substantially matches the center of the female screw hole 7a. As a result, the flange 2 is maintained parallel to the body panel 6 and is prevented from being mounted obliquely, the outer edge part of the flange 2 can be brought into close contact with the body panel 6, and watertight sealing property can be maintained to a high degree by the hole closing plug 1.

As a feature of the present embodiment, each of the elastic engaging pieces 4, 4 is provided with two types of engaging claws 41, 42 for engaging with the inclined surface of the thread of the female screw hole 7a of the weld nut 7. These engaging claws 41, 42 are a first engaging claw 41 positioned on the front end side of the elastic engaging piece 4, and a second engaging claw 42 positioned on the base end side of the elastic engaging piece 4 (the side connected to the support post lower part 32 of the support post 3) compared with the position of said first engaging claw 41.

These engaging claws 41, 42 protrude toward the outside of the elastic engaging piece 4 and are formed in a triangular cross section. Specifically, said engaging claws 41, 42 are formed so that the tips thereof are engaged with the slope of the thread corresponding to the lead angle of the thread of the female screw hole 7a of the weld nut 7. More specifically, with the triangle shape which is the sectional shape of each engaging claw 41, 42, in a state in which “hole closing plug 1” is not inserted in each hole 6a, 7a, that is, in a state in which elastic force is not acting on the elastic engaging pieces 4, 4 (see FIG. 3), the direction in which the apex is facing is slightly downward. The reason for this is that when the hole closing plug 1 is inserted into each of the holes 6a, 7a and each of the elastic engaging pieces 4, 4 comes into contact with the inner surface of the female screw hole 7a and elastically deforms toward the inner side (the support post 3 side), each elastic engaging piece 4, 4 is deformed in an upward-rising direction, and in this state, the apexes of the triangles, which are the cross-sectional shapes of the respective engaging claws 41, 42, face substantially outward, so as to ensure satisfactory engagement with the inclined surface of the thread of the female screw hole 7a of the weld nut 7.

Moreover, since the engaging claws 41, 42 of the respective elastic engaging pieces 4, 4 are engaged with the inclined face of the thread of the female screw hole 7a at the position facing in the radial direction, the positions of the engaging claws 41, 42 of one of the elastic engaging pieces 4 are shifted by half the height of the pitch of the screw thread relative to the positions of the engaging claws 41, 42 of the other elastic engaging piece 4. In this way, since the engaging claws 41, 42 are set at different height positions, each of the engaging claws 41 and 42 can be engaged so as to be in surface contact with the inclined surface of the thread of the female screw hole 7 a; this further ensures that the center of the support post 3 substantially match the center of the female screw hole 7a, and it is possible to reliably prevent the flange 2 from being obliquely attached to the body panel 6. Further, the outer edge part of the flange 2 can be reliably brought into close contact with the body panel 6, and the watertight sealing property can be maintained to an even higher degree by the hole closing plug 1.

Further, protrusions 43 are formed at the distal end parts of the elastic engaging pieces 4, 4 on the side of the elastic engaging piece 4 more distal than the first engaging claw 41. These protrusions 43 are formed in a shape that tapers toward the distal end side.

The insertion force required for inserting the hole closing plug 1 into the respective holes 6a, 7a is preferably determined to be 30 N or less so that the worker's burden is not ergonomically heavy; accordingly, it is preferable to determine the elasticity of the elastic engaging pieces 4, 4. For example, the shape of the tip of each of the engaging claws 41, 42 of each elastic engaging piece 4, 4 is a curved surface; this prevents excessive engaging of the thread of the female screw hole 7a, so that, for example, the contact resistance at the time of insertion of the hole closing plug 1 can be reduced, and the burden on the operator can be reduced. Additionally, this facilitates rotation about the axis of the hole closing plug 1 at the time of detachment, making it easier to retighten at the time of attachment.

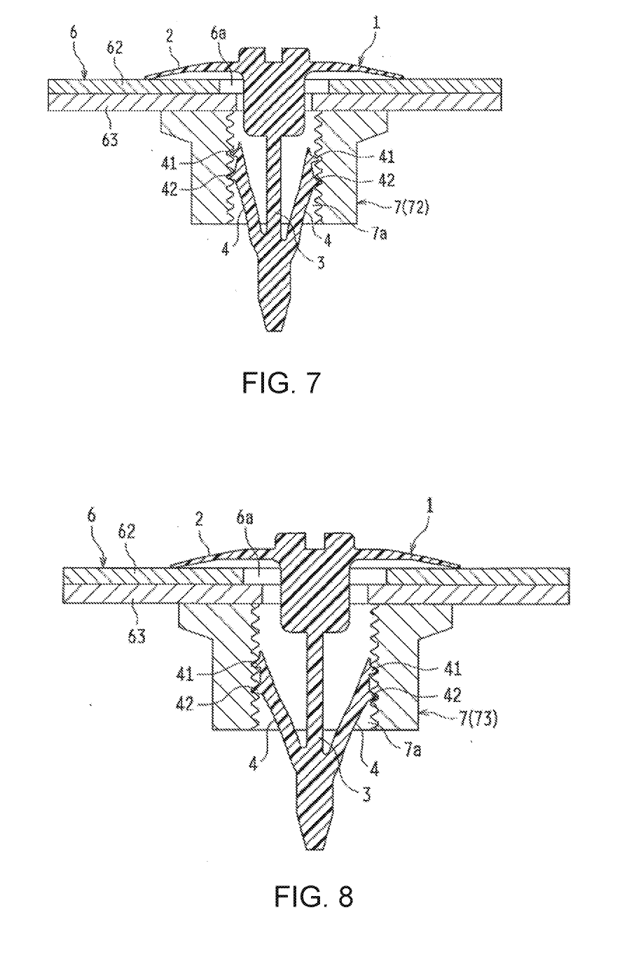

Further, as features of the first engaging claw 41 and the second engaging claw 42, the spacing between the first engaging claw 41 and second engaging claw 42 matches the pitch of female screws in each weld nut 7 (71-73; see FIGS. 6 to 8) of sizes (nominal diameter) M8, M10, M12. That is, as the type of the weld nut 7 (71-74; see FIGS. 6 to 9) fixed to the body panel 6 in the present embodiment, one of the sizes (nominal diameters) M8, M10, M12, M14 is selectively applied. Of these, the pitches of female screws in weld nuts 7 (71-73) of M8, M10 and M12 coincide with each other. The interval between the first engaging claw 41 and the second engaging claw 42 relative to the hole closing plug 1 matches the pitch of the female screw in the respective weld nuts 7 (71-73) of M8, M10 and M12. Therefore, it is possible to achieve a state in which both the first engaging claw 41 and the second engaging claw 42 are engaged with the valley of the female screw relative to the weld nut 7 (engaged with the inclined surface of the thread). In a state in which either the first engaging claw 41 or the second engaging claw 42 is engaged in the valley of the female screw of the weld nut 7, the other engaging claw is in a state facing the valley of the female screw relative to the weld nut 7 (see FIG. 7). In other words, the other engaging claw does not interfere with the thread of the female screw of the weld nut 7, so that a stable engaging state can be achieved.

Further, the shapes of the first engaging claw 41 and the second engaging claw 42 are the same as the shape of the valley of the female screw of each weld nut 7 (71-74) of sizes M8, M10, M12, M14. That is, as described above, when the hole closing plug 1 is inserted into the holes 6a, 7a, and the elastic engaging pieces 4, 4 come into contact with the inner surface of the female screw hole 7a and are elastically deformed toward the inside (toward the support post 3), each elastic engaging piece 4, 4 is deformed in a rising direction, and in this state, where the apexes of the triangle which is the cross-sectional shape of each engaging claw 41, 42 face substantially outward, the cross sectional shape of the engaging claws 41, 42 is designed to be the same shape as the shape of the valley of the female screw of each weld nut 7 (71-74).

Next, the operation when the hole closing plug 1 configured as described above is inserted into the receiving hole 6a of the body panel 6 and the female screw hole 7a of the weld nut 7 will be described.

In this insertion operation, the tip of the support post 3 is aligned with the receiving hole 6a of the body panel 6 and the female screw hole 7a of the weld nut 7, the upper surface of the flange 2 is pressed by the operator's finger, and the support post 3 is pushed as is, the elastic engaging pieces 4, 4 are elastically deformed radially inward, and the support post 3 and the elastic engaging pieces 4, 4 are inserted into the receiving hole 6a of the body panel 6 and the female screw hole 7a of the weld nut 7. In this insertion, one or both of the engaging claws 41, 42 of each elastic engaging piece 4, 4 are engaged so as to be brought into surface contact with the inclined surface of the thread according to the lead angle of the thread of the female screw hole 7a; as a result, the hole closing plug 1 is mounted in a state in which it is prevented from coming off from the weld nut 7, and the receiving hole 6a of the body panel 6 and the female screw hole 7a of the weld nut 7 are plugged.

Further, if a tool, such as a driver, is inserted into the groove 21 formed in the upper surface of the flange 2, and the flange 2 is rotated around the axis in the normal rotation direction of the screw of the weld nut 7 (for example, in the clockwise direction in plan view), the hole closing plug 1 is pushed along the screw thread to increase the fixing force of the hole closing plug 1 and to improve the watertight sealing property of the hole closing.

Moreover, when detaching the hole closing plug 1, a tool, such as a driver, may be inserted into the groove 21 and rotated in the reverse direction of the screw of the weld nut 7 (for example, in the counterclockwise direction in plan view). That is, by continuing the rotation of the flange 2, one or both of the engaging claws 41, 42 of the elastic engaging pieces 4, 4 engaged with the inclined surface of the thread are moved upward along the thread of the female screw hole 7a, and by this upward movement, the hole closing plug 1 is pulled out from the body panel 6. The removed hole closing plug 1 can be reused as is.

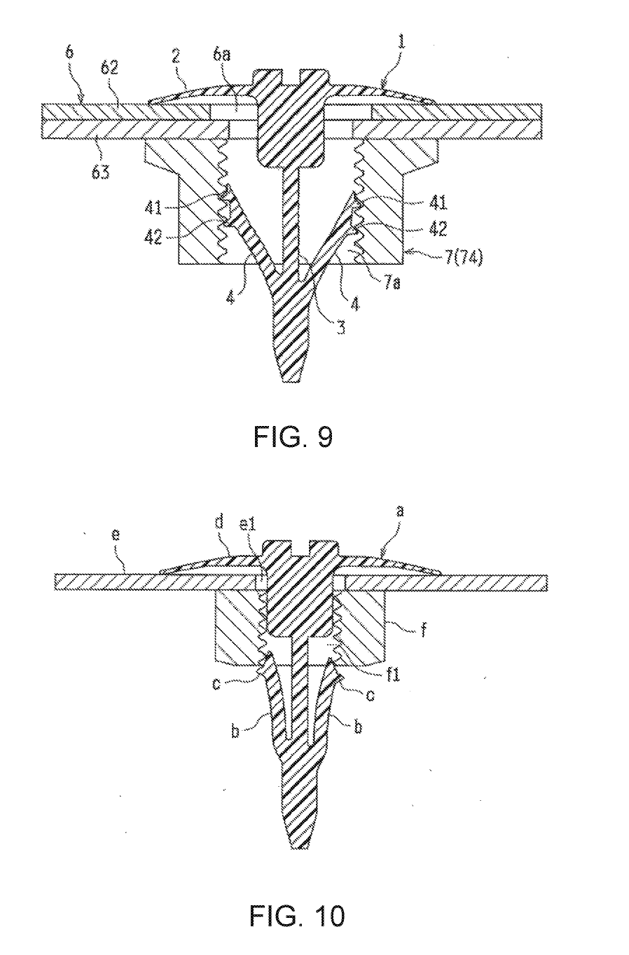

Hereinafter, the state in which the hole closing plug 1 is attached to the weld nut 7 of varying sizes (71-74) with the body panel 6 having various thicknesses will be described. Specifically, the states in which the hole closing plug 1 is respectively attached to each of the following will be described: a state in which weld nut 71 of size M8 is fixed to a body panel 6 (61) having a relatively small plate thickness dimension (see FIG. 6), a state in which weld nut 72 of size M10 is fixed to a body panel 6 (62, 63) having a relatively large plate thickness dimension (see FIG. 7), a state in which weld nut 73 of size M12 is fixed to a body panel 6 (62, 63) having a relatively large plate thickness dimension (see FIG. 8), and a state in which weld nut 74 of size M14 is fixed to a body panel 6 (62, 63) having a relatively large plate thickness dimension (see FIG. 9).

FIG. 6 is a cross-sectional view showing the state of mounting the hole closing plug 1 to a body panel 61 having a comparatively small plate thickness dimension (about 1.0 mm), to which a weld nut 71 of size M8 is fixed. As shown in FIG. 6, in the case where weld nut 71 of size M8 is fixed to the body panel 61 having a relatively small plate thickness dimension, the length of the interval between the surface position of the body panel 61 and the end surface of the weld nut 71 (lower end surface in FIG. 6) is relatively small.

In this case, between the first engaging claw 41 and the second engaging claw 42 provided on the respective elastic engaging pieces 4, 4 of the hole closing plug 1, only the first engaging claws 41, 41 positioned on the distal end sides of the elastic engaging pieces 4, 4 are engaged in the valley of the female screw in the weld nut 71. Further, the second engaging claws 42, 42 are located below the end surface (lower end surface) of the weld nut 71 and are not engaged with the valley of the female screw in the weld nut 71. That is, with the hole closing plug 1 the formation position of the first engaging claw 41 is set so that the interval between the lower surface of the flange 2 and the first engaging claw 41 is shorter than the interval between the surface position of the body panel 61 and the end surface (lower end surface in FIG. 6) of the weld nut 71. Further, with the hole closing plug 1, the formation position of the second engaging claw 42 is set so that the interval between the lower surface of the flange 2 and the second engaging claw 42 is longer than the interval between the surface position of the body panel 61 and the end surface (the lower end surface in FIG. 6) of the weld nut 71. As described above, in the mounting state of the hole closing plug 1 to the body panel 61 having a relatively small plate thickness dimension to which the weld nut 71 of size M8 is fixed, only the first engaging claws 41, 41 are engaged in the valley of the female screw of the weld nut 71, thereby preventing the hole closing plug 1 from coming out.

Further, since the projecting portions 43, 43 are formed on the distal end portions of the elastic engaging pieces 4, 4, a temporary dimensional variation occurs the pushing force onto the upper surface of the flange 2 is large, and even if the first engaging claws 41, 41 move to the side lower than the end surface (lower end surface) of the weld nut 71, the projecting portions 43, 43 are caught on the inner surface of the female screw hole 7a of the weld nut 72 so that all of the elastic engaging pieces 4, 4 do not penetrate downwardly more than the end surface of the weld nut 71. Therefore, when the hole closing plug 1 is pulled out, it is possible to prevent each of the elastic engaging pieces 4, 4 from being caught by the lower end surface of the weld nut 71 and damaging the elastic engaging pieces 4, 4.

In FIG. 10, as a conventional example, a case is shown wherein only one engaging claw C, C is provided on each elastic engaging piece b, b of the hole closing plug a, and the lengths of the elastic engaging pieces b, b are relatively short, so that the interval between the lower surface of the flange d and the engaging claws C, C is longer than the sum of the dimensions of body panel e and weld nut f of size M12. In such hole closing plug a, the engaging claws C, C of the elastic engaging pieces b, b penetrate the weld nut f and are positioned below the weld nut f, and because the engaging claws C, C cannot lock with the inclined surface of the thread of the weld nut f, the receiving hole e1 of the body panel e and the female screw hole f1 of the weld nut f cannot be stably closed by the hole closing plug a. In addition, when removing the hole closing plug a, it cannot be removed even by rotating the hole closing plug a, so the hole closing plug a is pulled out. At this time, each of the elastic engaging pieces b, b is caught on the lower surface of the weld nut f, and each of the elastic engaging pieces b, b is broken by the pulling-out force, so that there is a possibility that re-using it may become impossible.

In the present embodiment, since the first engaging claws 41, 41 are engaged in the valley of the female screw in weld nut 71, the receiving hole 6a of the body panel 61 and the female screw hole 7a of the weld nut 71 can be stably closed by the hole closing plug 1. Further, since the first engaging claws 41, 41 are engaged in the valley of the female screw of the weld nut 71, when detaching the hole closing plug 1, a tool is inserted into a groove 21 formed on the upper surface of the flange 2 of the hole closing plug 1, and the hole closing plug 1 is rotated about the axis of the flange 2; as the first engaging claws 41, 41 move along the valley of the female screw in the weld nut 71, the hole closing plug 1 can be satisfactorily removed, and the hole closing plug 1 will not be damaged, so that the plugging plug can be re-used.

FIG. 7 is a cross section view showing the attached state of the hole closing plug 1 relative to the fixing of weld nut 72 of size M10 on the body panel 6 having a relatively large (about 4.0 mm) total thickness dimension, by forming the body panel 6 by overlapping the two panel materials 62, 63. As shown in FIG. 7, in the case where the weld nut 72 having size M10 is fixed to the body panel 6 having a relatively large total thickness dimension, from among the first engaging claw 41 and the second engaging claw 42 provided on each elastic engaging piece 4, 4 of the hole closing plug 1, only the second engaging claws 42, 42 positioned on the base end sides of the elastic engaging pieces 4, 4 are engaged in the valley of the female screw in the weld nut 72. Also, the first engaging claws 41, 41 are in a position retracted from the inner surface of the female screw hole 7a of the weld nut 72 and are not engaged with the valley of the female screw in the weld nut 72. As described above, since the interval between the first engaging claw 41 and the second engaging claw 42 is equal to the pitch of the female screw in the weld nut 7 (72), the first engaging claws 41, 41 do not interfere with the thread of the female screw of the weld nut 7, and a stable engaging state can be realized. As described above, in the mounting state of the hole closing plug 1 relative to the fixing of weld nut 72 of size M10 to body panel 6 having a relatively large total thickness dimension, only the second engaging claws 42, 42 are engaged with the valleys of the screw, thereby preventing the hole closing plug 1 from coming out.

FIG. 8 is a cross section view showing the attached state of the hole closing plug 1 relative to the fixing of weld nut 73 of size M12 on the body panel 6 having a relatively large total thickness dimension, by forming the body panel 6 by overlapping the two panel materials 62, 63. As shown in FIG. 8, in the case where the weld nut 73 having size M12 is fixed to the body panel 6 having a relatively large total thickness dimension, both the first engaging claw 41 and the second engaging claw 42 provided on the respective elastic engaging pieces 4, 4 of the hole closing plug 1 are engaged in the valley of the female screw of the weld nut 73. As described above, since the interval between the first engaging claw 41 and the second engaging claw 42 is equal to the pitch of the female screw in the weld nut 73 of size M12, both the first engaging claw 4 1 and the second engaging claw 42 can be engaged in the valley of the female screw of the weld nut 7. As a result, the hole closing plug 1 is secured to prevent it from coming off.

FIG. 9 is a cross section view showing the attached state of the hole closing plug 1 relative to the fixing of weld nut 74 of size M14 on the body panel 6 having a relatively large total thickness dimension, by forming the body panel 6 by overlapping the two panel materials 62, 63. As shown in FIG. 9, in the case where the weld nut 74 having size M14 is fixed to the body panel 6 having a relatively large total thickness dimension, from among the first engaging claw 41 and the second engaging claw 42 provided on each elastic engaging piece 4, 4 of the hole closing plug 1, only the first engaging claws 41, 41 positioned on the distal end side of the elastic engaging pieces 4, 4 are engaged in the valley of the female screw in the weld nut 72. Also, the second engaging claws 42, 42 are in a position retracted from the inner surface of the female screw hole 7a of the weld nut 72 and are not engaged with the valley of the female screw in the weld nut 72. In other words, in the mounting state of the hole closing plug 1 relative to the fixing of weld nut 7 of size M14 to body panel 6 having a relatively large total thickness dimension, only the first engaging claws 41, 41 are engaged with the valleys of the screw, thereby preventing the hole closing plug 1 from coming out.

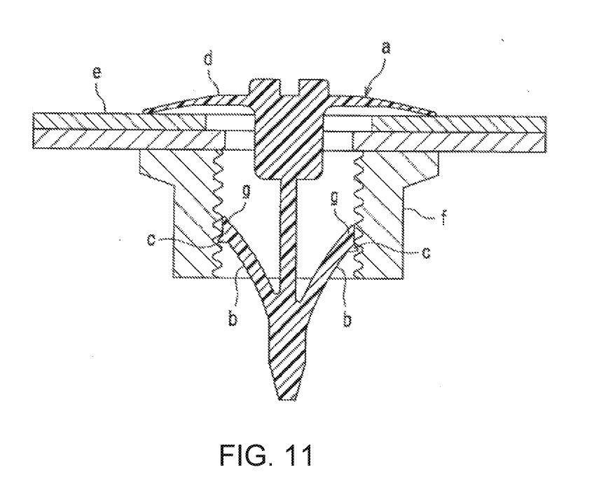

FIG. 11 is a cross sectional view of the case wherein, as a conventional example, a hole closing plug is applied to a weld nut f having size M14, in which only one engaging claw C, C is provided on each elastic engaging piece b, b of the hole closing plug a. In the case where only one engaging claw C, C is provided as described above, since the amount of inclination of each elastic engaging piece b, b is large, the protruding part g, g formed at the upper end part of each elastic engaging piece b, b interferes with the inner surface of the weld nut f, and there is a possibility that the engaging claws C, C cannot be engaged satisfactorily on the inclined face of the thread of the weld nut.

In the embodiment of the present invention, the first engaging claws 41, 41 of the elastic engaging pieces 4, 4 whose incline is great are engaged in the valley of the female thread of the weld nut 71; therefore, the receiving hole 6a of the body panel 61 and the female screw hole 7a of the weld nut 71 can be stably closed by the hole closing plug 1.

As explained above, in the present embodiment, the interval between the first engaging claw 41 and the second engaging claw 42 matches the pitch of the female screw of the weld nut 7 (71-73) of sizes M8, M10 and M12. Further, the shapes of the first engaging claw 41 and the second engaging claw 42 are the same as the shapes of the valley of the female screw in each weld nut 7 (71-74) of sizes M8, M10, M12 and M14; therefore, one kind of hole closing plug 1 can correspond to various weld nuts 7 (71-74). That is, it is possible to realize a mounting configuration of the hole closing plug 1 according to various sizes of the weld nut 7 (71-74), such as a mounting state when only the first engaging claw 41 is engaged with the inclined face of the thread of the female screw hole 7a of the weld nut 7 (mounting state relative to weld nut 71 of M8 and mounting state relative to weld nut 74 of M14 described above), a mounting state when only the second engaging claw 42 is engaged with the inclined face of the thread of the female screw hole 7a of the weld nut 7 (mounting state relative to weld nut 72 of M10 described above), or a mounting state when both the first engaging claw 41 and the second engaging claw 42 are engaged with the inclined surface of the thread of the female screw hole 7a of the weld nut 7 (mounting state relative to weld nut 73 of M12). In this way, versatility of the hole closing plug 1 can be enhanced.

It should be noted that the present invention is not limited to the above-described embodiments, and all modifications and applications encompassed within the scope of the claims and the range equivalent thereto are possible.

For example, in the above-described embodiment, a description is given of a case wherein the present invention is applied as a plug 1 for closing a female screw hole to be used to close a receiving hole 6a formed in the body panel 6 of an automobile and a female screw hole 7a of a weld nut 7 fixed to the back surface of the body panel 6. The present invention is not limited to this and may be applied to an object used for closing a hole in another member.

The present invention is applicable to using a plug for closing a female screw hole used to close a receiving hole and a female screw hole of a weld nut relative to a configuration in which a weld nut is fixed to a body panel corresponding to the receiving hole formed in the body panel of an automobile.

It will be appreciated by persons skilled in the art that the above embodiments have been described by way of example only, and not in any limitative sense, and that various alterations and modifications are possible without departure from the scope of the invention as defined by the appended claims.

What is claimed is:

1. A plug for closing a female screw hole used for closing the hole of a mounted member and the female screw hole of a female screw member for a configuration in which a female screw member is fixed to the mounted member corresponding to a hole formed on the mounted member;
wherein the plug for closing a female screw hole is characterized by the provision of a flange sized to cover the entire hole of the mounted member; a support post extending from a central portion of the flange; and at least a pair of elastic engaging pieces with the proximal end connected to the support post, so that as they approach the flange from the proximal end toward the distal end they move away from the support post;
wherein each of the elastic engaging pieces is provided with a first engaging claw positioned on the front end side of the elastic engaging piece, and a second engaging piece positioned farther on the base end side of the elastic engaging piece with respect to the first engaging claw;
wherein the interval between the first engaging claw and the second engaging claw matches the pitch of the female screw in each female screw member of at least sizes M8, M10 and M12; and the shape of the first engaging claw and the second engaging claw is the same as the shape of the valley of the female screw in each female screw member of sizes M8, M10, M12 and M14.

2. A plug for closing a through hole of a workpiece from a first side and a female fastener partially defining a threaded bore attached to the workpiece on the second side of the workpiece opposite to the first side, the threaded bore of the female fastener aligned with the workpiece through hole and including a female screw thread with a screw pitch and a screw valley in at least one of the sizes M8, M10, M12; and M14; and wherein the plug comprises:
a support post defining an axis and including a first end and a second end;
a flange extending radially from the support post proximate to the first end and the flange is sized to completely cover the workpiece through hole on the first side;
an elastic engaging leg including a proximal end and a free end, the proximal end located on the support post proximate to the second end, and the engaging leg extending from the engaged end axially toward the flange and radially outward from the support post to the free end;
a first engaging claw having a shape pointing radially outward and located proximate the free end of the engaging leg;
a second engaging claw having the shape pointing radially outward and located at an interval along the engaging leg from the first engaging claw;
wherein the interval matches the pitch of the female screw in each female screw member of at least sizes M8, M10 and M12; and the shape is the same as the valley of the female screw in each female screw member of sizes M8, M10, M12 and M14.

3. A plug according to claim 2, wherein the elastic engaging leg is a first engaging leg and the plug further comprising a second engaging leg.

4. A plug according to claim 3, wherein the first engaging leg and second engaging leg extend from the support post in radially opposite directions.

5. A plug according to claim 2, wherein the first engaging claw and second engaging claw are each a prong, and the shape is of a triangular cross section.
